(19) United States
(12) Patent Application Publication
(10) Pub. No.: US 2017/0279798 A1
(43) Pub. Date: Sep. 28, 2017

(54) MULTI-FACTOR AUTHENTICATION SYSTEM AND METHOD

(71) Applicant: Matthew C. Reynolds, Bellevue, WA (US)

(72) Inventor: Matthew C. Reynolds, Bellevue, WA (US)

(21) Appl. No.: 15/470,808

(22) Filed: Mar. 27, 2017

Related U.S. Application Data
(60) Provisional application No. 62/313,675, filed on Mar. 25, 2016.

(51) Int. Cl. H04L 29/06; H04L 9/32

(52) U.S. Cl. CPC H04L 63/0853; H04L 9/3234; H04L 63/107; H04L 63/08; G06F 21/34

(57) ABSTRACT

To authorize a client device to access a secure resource hosted on a web server, the present methods and systems may provide executable instructions including a challenge token to the client device, which, in turn, may cause the client device to provide executable instructions, including the challenge token, to a mobile client device via a persona area network. The executable instructions provided to the mobile client device may request the mobile client device to return a verification token. The mobile client device may compare the provided challenge token to a challenge token stored locally. If the challenge tokens match, the mobile client device may provide a verification token to the client device via the personal area network, which may in turn provide the verification token to the web server. The web server may compare the verification token provided by the client device to a verification token provided by the present methods and systems. If the verification tokens match, the web server may authorize the access to the secure resource.

### FIELD

The present disclosure relates to network security and more particularly, to multifactor authentication.

### BACKGROUND

User authorization may be performed with the following methods.

Users provide their credentials to a web server with a username and password as credentials. The credentials are encrypted before being sent over the network to prevent interception.

Once the user has logged into the web server, the web server may return a secure HTTP cookie (“secure cookie”), which is stored on the user's computer, and used as secondary authorization.

When the user logs into a web server, the web server can send a random number to their phone, which the user sends back in addition to their username and password as a one-time credential.

The user can use an external device which has a time-based shared secret key with the web server, which the user enters in addition to their username and password as a one-time credential.

The user can provide additional credentials, such as a smartcard or thumbprint (or other biometric identifier) in addition to their username and password.

However, if the user receives a random number from the website on their phone, they have to activate their phone, and enter the number correctly on the web page.

Likewise, if an HTTP cookie is stored on the user's computer, it can be retrieved by an attacker who has access to the computer, and does not provide additional authentication if the user logs into a different computer.

Also, if the user is required to use their thumbprint, once it is obtained by an attacker, he cannot change it like a password.

Additionally, smartcards require specialized hardware on the computer.

Furthermore, if a time-based secret key is obtained from the website by an attacker, he can use it to impersonate the user.

In the case of biometric authentication and TOTP tokens, if a hacker breaks into the authorization server, they can impersonate any of its users.

### BRIEF DESCRIPTION OF THE DRAWINGS

FIG. 1 illustrates a network topology of an exemplary client/server-based identity verification management (“IVM”) system in accordance with various embodiments of the present methods and systems.

FIG. 2 illustrates several components of an exemplary client device in accordance with various embodiments of the present methods and systems.

FIG. 3 illustrates several components of an exemplary server in accordance with various embodiments of the present methods and systems.

FIG. 4 illustrates a first exemplary series of communications between various devices in accordance with various embodiments of the present methods and systems.

FIG. 5 illustrates a second exemplary series of communications between various devices in accordance with various embodiments of the present methods and systems.

FIG. 6 illustrates a block diagram of an exemplary local IVM data update routine in accordance with various embodiments of the present methods and systems.

FIG. 7 illustrates a block diagram of an exemplary remote IVM data update sub-routine in accordance with various embodiments of the present methods and systems.

FIG. 8 illustrates a block diagram of an exemplary secure access routine in accordance with various embodiments of the present methods and systems.

FIG. 9A-B illustrate a block diagram of an exemplary identity verification sub-routine in accordance with various embodiments of the present methods and systems.

FIG. 10 illustrates a block diagram of an exemplary remote IVM sub-routine in accordance with various embodiments of the present methods and systems.

FIG. 11 illustrates a block diagram of an exemplary identity verification script in accordance with various embodiments of the present methods and systems.

FIG. 12 illustrates a block diagram of an exemplary identity verification sub-script in accordance with various embodiments of the present methods and systems.

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file servers, computer servers, and/or memory storage devices. Each of these conventional distributed computing components is accessible by the processor via a communication network, which may include, but is not limited to, the Internet.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of certain exemplary aspects of various embodiments of the present methods and systems with reference to the accompanying Drawings. There is no intent to limit the scope of the systems, methods, and the like as are defined in the Claims which follow this Description to the particular embodiments described herein. On the contrary, the intent is to provide sufficient examples in order to enable any person skilled in the art to which the present Specification pertains to make and use all alternatives, modifications, and equivalents of the present systems and methods. In alternate embodiments, additional devices, or combinations of illustrated devices, may be added to, or combined, without limiting the scope to the embodiments disclosed herein. For example, the embodiments set forth below are primarily described in the context of a general-purpose computer in data communication with a “smartphone” via a proximal (i.e. relatively short range) wireless networking protocol such as Bluetooth. However, these embodiments are exemplary and the scope of the present methods and systems are in no way limited by the characteristics and components of the specific examples described

### An Exemplary Client/Server-Based Identity Verification Management System

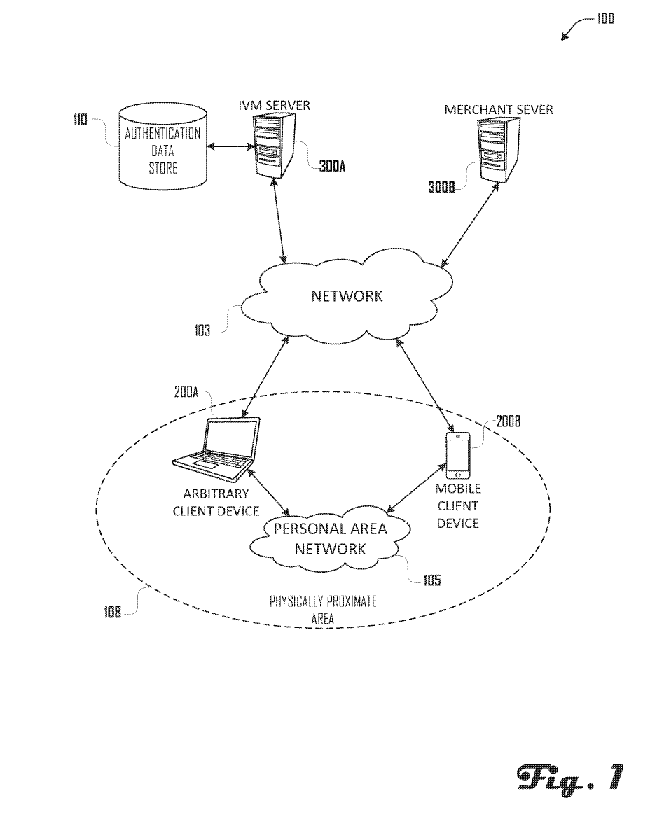

FIG. 1 illustrates a network topology of an exemplary client/server-based identity verification management (“IVM”) system 100 in accordance with various embodiments of the present methods and systems.

An arbitrary client device 200A, an identity verification management (“IVM”) server 300A, and a web server 300B may each be in data communication with a network 103. In various embodiments, network 103 may include the Internet, one or more local area networks (“LANs”), one or more wide area networks (“WANs”), cellular data networks, and/or other data networks. Network 103 may, at various points, be a wired and/or wireless network.

A mobile client device 200B may also be in data communication with network 103. Arbitrary client device 200A and mobile client device 200B may also be in data communication with one another via a personal area network (“PAN”) 105.

PAN 105 may, for example, be implemented according to a known communication standard such as Bluetooth, WiFi, Ethernet, or the like. Unlike data communication via network 103, data communication via PAN 105 may require arbitrary client device 200A and mobile client device 200B to be in relative physical proximity to one another, as indicated by physically proximate area 108.

IVM server 300A may be in data communication with an authentication data store 110. The functionality of IVM server 300A is described in more detail below.

Web server 300B may be operated by a commercial (or non-commercial) enterprise. In some embodiments, IVM server 300A may also be operated by the commercial enterprise. In other embodiments, authentication verification server 300A may operate cooperatively with, but independently of, the commercial enterprise.

In these and other embodiments, arbitrary client device 200A may be a computing device having an arbitrary form factor including a general purpose computer (including “laptop,” “notebook,” “tablet” computers, or the like); a mobile phone; a wearable computing device (including watches, glasses, or the like); a motor vehicle head unit; or the like. For simplified exemplary purposes, arbitrary client device 200A is depicted as a laptop computer.

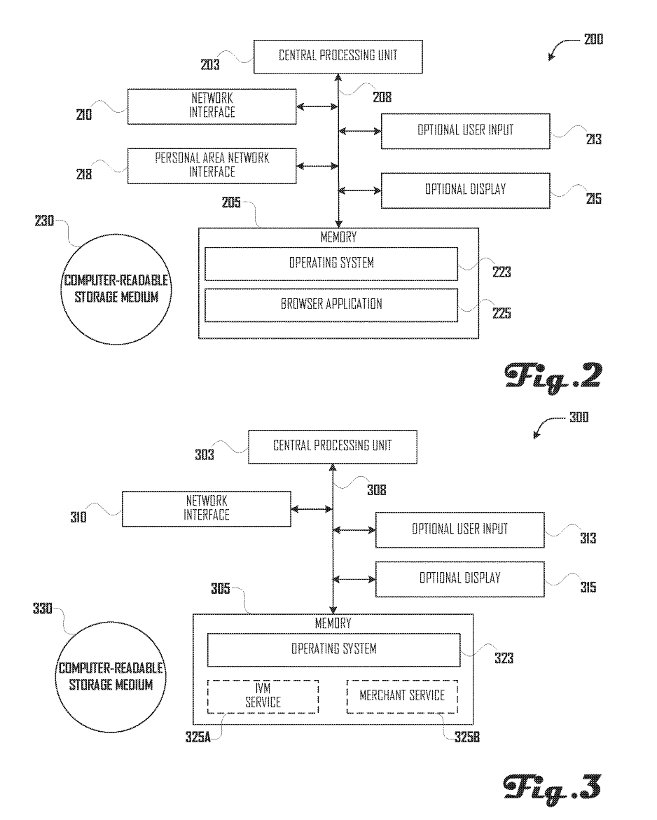

In these and other embodiments, mobile client device 200B may be a mobile computing device having a form factor including a mobile phone; wearable computing device (including watches, glasses, or the like). As is explained in more detail below, second client device 300 may be a portable or mobile device that is carried (or worn) by a primary user. For simplified exemplary purposes, first client device 200 is depicted as a laptop computer. The primary functional components of an exemplary, form-factor-independent first client device 200 are described below in reference to FIG. 2.

As is explained in more detail below, arbitrary client device 200A and mobile client device 200B may both be associated with a common user identity (not shown) corresponding to an authorized user of the commercial enterprise. As relevant to the present methods and systems, the primary distinction between arbitrary client device 200A and mobile client device 200B is that arbitrary client device 200A may have a relatively weak association with the common user identity, e.g. the user identity may be one of many users of the arbitrary client device, while mobile client device 200B may have a relatively strong association with the user identity, e.g. the user identity may be the primary user of the mobile client device. The primary functional components of an exemplary, form-factor-independent client device 200 are described below in reference to FIG. 2.

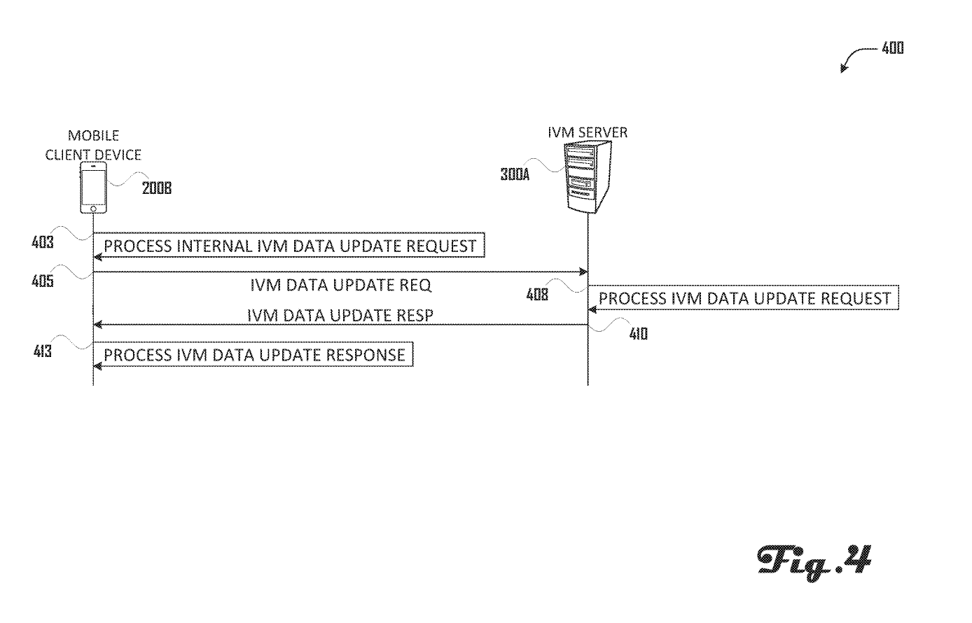

In various embodiments, IVM server 300A and web server 300B may be networked computing devices generally capable of accepting requests over network 103, e.g. from arbitrary client device 200A, mobile client device 200B, each other, and/or other networked computing devices (not shown), and providing responses accordingly. The primary functional components of an exemplary server 300, such as IVM server 300A and web server 300B, are described below in reference to FIG. 3.

### Exemplary Client Device

FIG. 2 illustrates several components of an exemplary client device 200, such as either of arbitrary client device 200A and mobile client device 200B. However, the present methods and systems do not depend on any particular internal configuration or functionality of a client device.

As shown in FIG. 2, exemplary client device 200 includes a central processing unit 203 in data communication with memory 205 via a bus 208. Central processing unit 203 is an electronic circuit designed to obtain instruction of a computer program, e.g. from memory 205, carry out the instructions, e.g. by performing the arithmetic, logical, control and input/output (I/O) operations specified by the program's instructions. Memory 205 generally comprises some or all of: random access memory (RAM), read-only memory (ROM), and/or a permanent mass storage device, such as a disk drive, flash memory, or the like. Bus 208 is a communication system that transfers data between components within client device 200, and encompasses any related hardware components (wire, optical fiber, etc.) and software, including communication protocols; the data communications between various components of client device 200 may be accomplished by wired and/or wireless connections.

Client device 200 may also include a network interface 210 for connecting to a network such as network 103; one or more optional user input device(s) 213, e.g. an alphanumeric keyboard, keypad, a mouse or other pointing device, a touchscreen, and/or a microphone (or a user input port for connecting an external user input device); optional display 215 (or a display input port for connecting to an external display device); and the like, all interconnected, along with the network interface 210, to central processing unit 203 and memory 205 via bus 208. Client device 200 may also include a personal area network interface 218 for connecting to a personal area network, such as PAN 108. In some embodiments, a client device 200 may include many more components than those shown in FIG. 2, such as a global positioning module. However, it is not necessary that these, generally conventional, components be shown in order to disclose an illustrative embodiment.

Memory 205 of exemplary client device 200 may store program code, executable by central processing unit 203, corresponding to an operating system 223, as well as program code corresponding to various software applications, such as a browser application 225 and other software applications (not shown). Operating system 223 and such various software applications may be loaded into memory 205 via network interface 210 or via a computer readable storage medium 230, such as a hard-disk drive, a solid-state drive, an optical disc, a removable memory card, and/or the like.

In operation, operating system 223 manages the hardware and software resources of client device 200 and provides common services and memory allocation for various software applications, such as browser application 225. For hardware functions such as network communications via network interface 210 and personal area network interface 218, receiving data via input 213, outputting data via optional display 215, and allocation of memory 205 for various software applications, such as browser application 225, operating system 223 acts as an intermediary between software executing on the client device and the device's hardware.

For example, operating system 223 may cause an iconic representation of available software applications, such as browser application 225, to be presented via display 215. If client device 200 obtains an indication via user input 213, e.g. from a user of the client device, a desire to use a specific software application, operating system 223 may instantiate a corresponding application process (not shown), i.e. cause central processing unit 203 to begin executing the executable instructions of the application and allocate a portion of memory 205 for its use.

Browser application 225 may be a software application for retrieving, processing, presenting, and traversing information resources on a network, such as network 108. Although browser application 225 may be primarily intended to use the World Wide Web, it may also be used to access information resources provided by remote servers in private networks. An information resource may be a web page, an image, a video, or other piece of content and may be identified by a Uniform Resource Identifier (URI/URL) on network 108. An information resource may also provide browser application 225 executable program code for web applications, i.e. a software application that runs in and is rendered by browser application 225.

In the case of a web application, browser application 225 may act as an intermediary between a software service operating on a remote server, such as IVM server 300A and/or web server 300B, and the operating system 223.

Although an exemplary client device 200 has been described with hardware components that generally conforms to conventional general purpose computing devices, a client device may be any of a great number of devices capable of communicating with network 103 and executing instructions for performing either 3P customer client application 228A and/or 3P-SP client application 228B.

### Exemplary Server

FIG. 3 illustrates several components of an exemplary server 300, such as IVM server 300A and web server 300B. However, the present methods and systems do not depend on any particular internal configuration or functionality of a server.

As shown in FIG. 3, exemplary server 300 includes a central processing unit 303 in data communication with memory 305 via a bus 308. Central processing unit 303 is an electronic circuit designed to carry out instructions of a computer program, e.g. obtained from memory 305, by performing the basic arithmetic, logical, control and input/output (I/O) operations specified by the program's instructions. Memory 305 may generally include some or all of random access memory (RAM), read-only memory (ROM), and/or a permanent mass storage device, such as a disk drive, flash memory, or the like. Bus 308 is a communication system that transfers data between components within exemplary server 300, and includes any related hardware components (wire, optical fiber, etc.) and software, including communication protocols.

Server 300 may also include a network interface 310 for connecting to a network such as network 103, one or more optional user input device(s) 313, e.g. an alphanumeric keyboard, keypad, a mouse or other pointing device, a touchscreen, and/or a microphone, (or a user input port for connecting an external user input device) and/or an optional display 315 (or a display port for connecting an external display device), both interconnected along with the network interface 310 via bus 308. In some embodiments, server 300 may include many more components than those shown in FIG. 3. However, it is not necessary that all of these generally conventional components be shown in order to disclose an illustrative embodiment.

Memory 305 may store an operating system 323 and program code for various software services 323. For example, IVM server 300A may include executable instructions for performing IVM service 323A (indicated by dotted lines) and web server 300B may include executable instructions for performing a merchant service 323B (indicated by dotted lines).

Program code for these and other such software services (not shown) may be loaded into memory 305 from a non-transient computer readable storage medium 330 using a drive mechanism (not shown) associated with the non-transient computer readable storage medium, such as, but not limited to, a DVD/CD-ROM drive, memory card, or the like. Software components may also be loaded into memory 305 via the network interface 310. Server 300 may also communicate via bus 308 with a database (not shown), such as IVM data store 105, or other local or remote data store.

In operation, operating system 323 manages the hardware and software resources of server 300 and provides common services and memory allocation for various software services, such as IVM service 323A or merchant service 323B. For hardware functions, such as network communications via network interface 310 and allocation of memory 305 for various software services, such as IVM service 323A, operating system 323 may act as an intermediary between software executing on server 300 and the server's hardware.

Although an exemplary server 300 has been described having hardware components that generally conform to a conventional general purpose computing device, a server may be any of a great number of devices capable of communicating with network 103 and executing instructions for performing IVM service 323A and/or merchant service 323B.

In some embodiments, a server 300 may comprise one or more replicated and/or distributed physical or logical devices. In some embodiments, IVM server 300A and web server 300B may be embodied by the same physical device. The present methods and systems do not depend on any particular internal configuration of server 300.

### Exemplary User Identity Verification System and Methods

Referring again to FIG. 1, an application, such as browser application 225A, operating on arbitrary client device 200A may provide a log in request, or another type of secure access request, specifying a user identifier to a service, such as merchant service 325B, operating on web server 300B. In accordance with various embodiments, the present methods and systems may authorize the requested data communication session by verifying that another client device that is also associated with the specified user identifier, such as mobile client device 200B, is in physical proximity of the arbitrary client device.

Some embodiments may utilize three types of tokens: verification tokens, challenge tokens, and manual verification tokens. As is explained in more detail below, verification tokens are used to validate the session under “normal” circumstances; challenge tokens are sent from arbitrary client device 200A to mobile client device 200B; and manual verification tokens are sent from mobile client device 200B to the arbitrary client device 200A if the does not have a secure cookie from the website. These tokens may be provided to mobile client device 200B from IVM server 300A in advance of an authorization request.

IVM server 300A may also send an encryption key to web server and mobile client device 200B, which may be used to encrypt the session between the arbitrary client device 200A and the web server.

In some embodiments, IVM server 300A may provide verification, challenge, and manual verification tokens and session encryption keys to mobile client device 200B in advance of an authorization request. The keys and tokens are sent with an authorizing domain identifier, and an expiration date. Such a “pre-synching” operation allows mobile client device 200B to authorize a data communication session regardless of whether the mobile client device is in data communication with IVM server 300A at the time of the authorization request. In such an embodiment, the tokens and keys may be periodically refreshed/updated while mobile client device is in data communication with IVM server 300A.

Upon obtaining the secure access request from arbitrary client device 200A, web server 300B may make an identity verification request to IVM server 300A. The identity verification request may include a unique user identifier. IVM server 300A may then look up an identity verification data structure associated with the provided unique user identifier.

An identity verification data structure associated with a unique user identifier may include a data communication address associated with a mobile client device, data records corresponding to tokens that may have been previously provided to the mobile client device and associated token expiration dates, data records corresponding to previous data communication session authorizations/authorization attempts, and the like.

Using information obtained from the identity verification data structure, IVM server 300A may (1) select a token set and a public/private encryption key pair for the current data communication session authorization, (2) provide a secure access response to web server 300B including unencrypted versions of the selected token set and the public key from the selected key pair and, if necessary, (3) provide a secure session client authorization request to the mobile client device including the token set and the private key from the selected key pair.

Merchant service 325B may provide a log-in page to browser application 225A responsive to the secure access request. The log-in page may include a request for a secure cookie (or the like) associated with a previous secure data communication session between merchant service 325B and browser application 225A. (A secure cookie is a cookie that may only be read over a secure connection by a server whose domain matches the domain that the secure cookie was written with.)

If browser application 225A provides the requested secure cookie, indicating a previous secure data communication session between the browser application and merchant service 325B, the merchant service may provide executable instructions including the challenge token to browser application 225A, which, in turn, may cause browser application 225A to provide executable instructions, including the challenge token obtained from IVM service 325A, to mobile client device 200B via PAN 105. The executable instructions provided to mobile client device 200B may request browser application 225B to return the verification token obtained from IVM service 325A. Browser application 225B may compare the challenge token provided by merchant service 325B via browser application 225A to the challenge token provided by IVM service 325A. If the challenge tokens match, browser application 225B may provide the unencrypted verification token provided by IVM service 325A to browser application 225B via PAN 105, which may in turn provide the verification token to merchant service 325B via network 103. Merchant service 325B may compare the verification token provided by browser application 225B via browser application 225A to the verification token provided by IVM service 325A. If the verification tokens match, merchant service 325B may authorize the requested data communication session.

In some embodiments, mobile client device 200A is provided with a private encryption key and web server 300B is provided with a corresponding public encryption key. Mobile client device 200A provides the private key to arbitrary client device 200B, and the arbitrary client device and web server 300B may use the private/public encryption key pair encrypt/decrypt communications for the data communication session.

If browser application 225A does not provide the requested secure cookie, merchant service 325B may provide an alternate set of executable instructions to browser application 225A, which, in turn, may cause browser application 225A to provide executable instructions to mobile client device 200B via PAN 105. The executable instructions provided to mobile client device 200B may (1) cause the mobile client device to provide an authentication prompt, e.g. via display 215B, identifying the URI of merchant service 325B and (2) require a manual response to the authentication prompt, e.g. obtained via user input 213. Upon obtaining the manual response, mobile client device 200B may return the manual verification token provided by IVM service 325A to browser application 225A via PAN 105. Browser application 225A may provide the manual verification token to merchant service 325B via network 103. Merchant service 325B may compare the manual verification token provided by browser application 225B via browser application 225A to the manual verification token provided by IVM service 325A. If the manual verification tokens match, merchant service 325B may authorize the requested data communication session.

### A First Exemplary Series of Communications

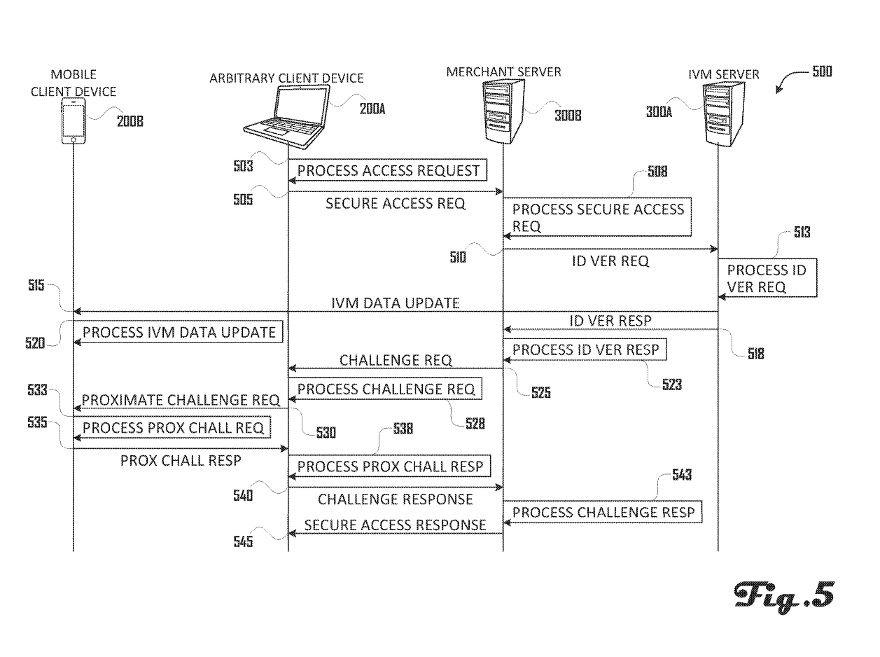

FIG. 4 illustrates a first exemplary series of communications 400 between mobile client device 200B and IVM server 300A corresponding to an optional “pre-synching” of IVM data between the mobile client device and the IVM server. During the pre-synching process, mobile client device 200B may be communicating directly with IVM server 300A, e.g. via a network such as network 103.

Referring first to FIG. 4, mobile client device 200B may process 403 an internal IVM data update request. For example, mobile client device 200B may be configured to generate an internal IVM data update request at a regular interval.

Mobile client device may provide an IVM data update request 405 to IVM server 300A. The IVM data update request may include an identifier, such as a user identifier and/or a mobile client device identifier.

IVM server 300A may process 408 IVM data update request 405. For example, IVM server 300A may search authentication data store 110 for an identity verification data structure associated with the identifier provided in the IVM data update request.

IVM server 300A may provide an IVM data update response 410 to mobile client device 200B. IVM data update response 410 may include one or more token sets (each token set may include a verification token, a manual verification token, and a challenge token) and expiration date(s) and private encryption key(s) associated with the token sets.

Mobile client device 200B may process 413 IVM data update response 410. For example, mobile client device 200B may store the token sets and associated expiration dates and/or encryption keys in memory 205.

### A Second Exemplary Series of Communications

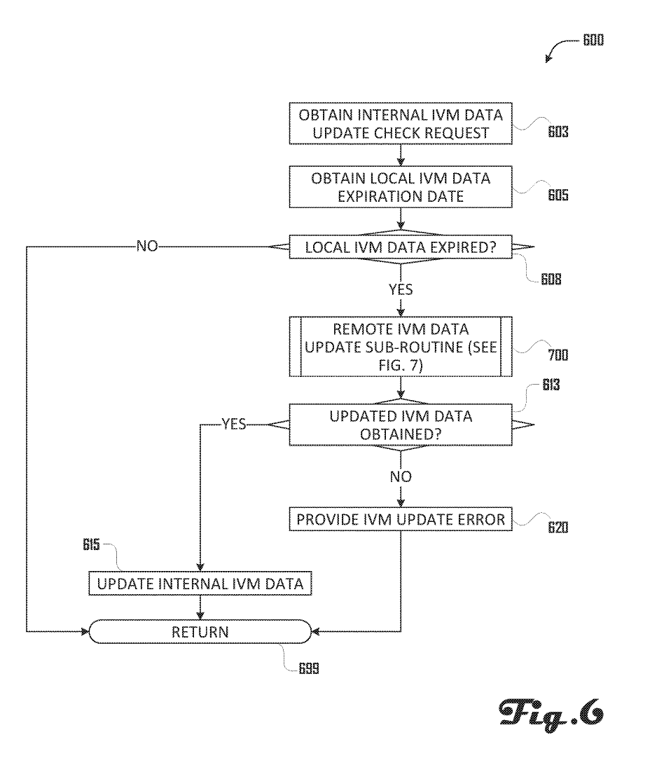

FIG. 5 illustrates a second exemplary series of communications 500 between mobile client device 200B, IVM server 300A, arbitrary client device 200A, and web server 200B in accordance with various embodiments of an IVM system, such as the IVM systems described above, and relating to providing user identity verification services. During second exemplary series of communications 500, mobile client device 200B may be communicating with IVM server 300A via network 103 and with arbitrary client device 200A via PAN 105.

Arbitrary client device 200A may process 503 an access request. For example, arbitrary client device 200A may obtain an indication directing it to access a URI associated with web server 300B.

Arbitrary client device 200A may then provide a secure access request 505 to web server 300B.

Web server 300B may process 508 secure access request 505 and provide an identity verification request 510 to IVM server 300A.

IVM server 300A may process 513 identity verification request 510 and provide an IVM data update 515 to mobile client device 200B and an identity verification response 518 to web server 300B. IVM data update 515 may include a token set and a private encryption key. Identity verification response 518 may include the token set and the public encryption key corresponding to the private encryption key provided in IVM data update 515.

Mobile client device 200B may process 520 IVM data update 515, for example by storing the token set and private key in memory 205B.

Web server 300B may process 523 identity verification response 518, for example, by encrypting the challenge token using the public encryption key and providing a challenge request 525 to arbitrary client device 200A. Challenge request 525 may request a secure cookie from arbitrary client device 200A.

Arbitrary client device 200A may process 528 challenge request 525 and provide a proximate challenge request 530 to mobile client device 200B. Proximate challenge request may include the encrypted challenge token and is provided over PAN 105.

Mobile client device 200B may process 533 proximate challenge request 530. For example, mobile client device may: decrypt the encrypted challenge token using the private encryption key; compare the decrypted challenge token to the challenge token obtained from IVM server 300A; and, if the challenge tokens match, encrypt the verification token (or the manual verification token) using the private encryption key and provide a proximate challenge response 535 to arbitrary client device 200A including the encrypted verification token (or the encrypted manual verification token). Proximate challenge response 535 is provided over PAN 105.

Arbitrary client device 200A may process 538 proximate challenge response 535 and provide a corresponding challenge response 540 to web server 300B.

Web server 300B may process 543 challenge response 540. For example, web server 300B may: decrypt the verification token (or the manual verification token) using the public encryption key; compare the decrypted verification token (or manual verification token to the verification token (or manual verification token) obtained from IVM server 300A; and, if the verification tokens match, provide an affirmative secure access response 545 to arbitrary client device 200A.

### Local IVM Data Update Routine

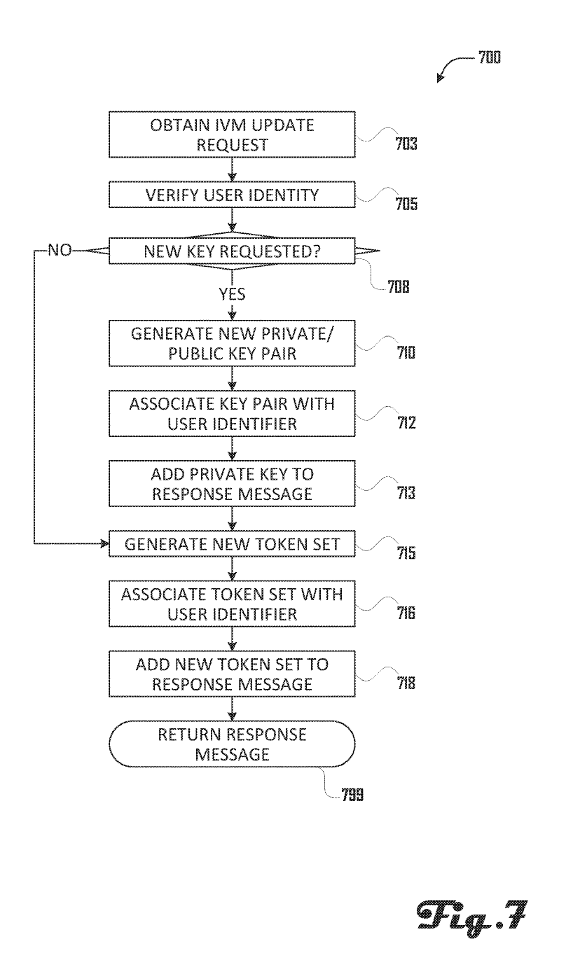

FIG. 6 illustrates an exemplary local IVM data update routine 600. Local IVM data update routine 600 may represent a portion of the functionality of an application being executed by central processing unit 203B of mobile client device 200B in cooperation with various other hardware and software components of the mobile client device.

Local IVM data update routine 600 may obtain internal IVM data check request at execution block 603.

Local IVM data update routine 600 may obtain a local data expiration date at execution block 05.

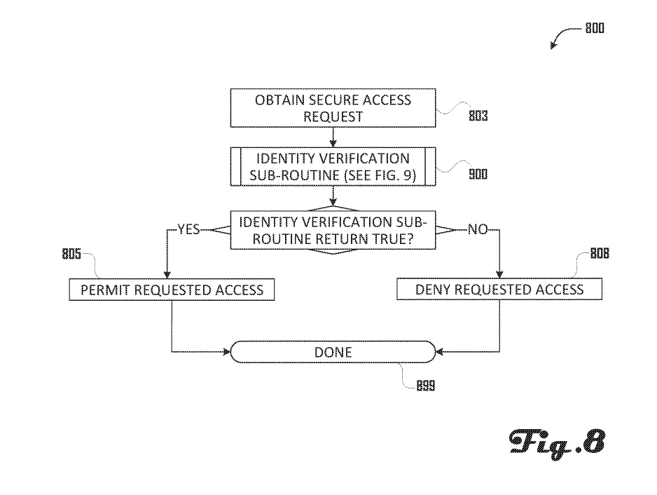

At decision block 608, if the local IVM data is expired, then local IVM data update routine 600 may call remote IVM data update remote IVM data update sub-routine 700, described below in reference to FIG. 7 and which may return new/updated IVM data, including one or more token sets and/or a private encryption key; otherwise local IVM data update routine 600 may proceed to return block 699.

At decision block 613, if updated IVM data has been obtained from remote IVM data update sub-routine 700, then local IVM data update routine 600 may proceed to execution block 615; otherwise local IVM data update routine 600 may proceed to execution block 620.

Local IVM data update routine 600 may update the internal IVM data structures updated IVM data obtained from remote IVM data update remote IVM data update sub-routine 700 at execution block 615.

Local IVM data update routine 600 may provide in IVM update error message at execution block 620.

Local IVM data update routine 600 may terminate at return block 699.

### Remote IVM Data Update Sub-Routine

FIG. 7 illustrates an exemplary remote IVM data update sub-routine 700. Remote IVM data update sub-routine 700 may represent a portion of the functionality of IVM service 325A being executed by central processing unit 303A of IVM server 300A in cooperation with various other hardware and software components of the present methods and symptoms.

Remote IVM data update sub-routine 700 may obtain in IVM data update request at execution block 703.

Remote IVM data update sub-routine 700 may verify a user identifier provided in the IVM update request at execution block 705.

At decision block 708, if a new private key is requested in the IVM update request, then remote IVM data update sub-routine 700 may proceed to execution block 710; otherwise, remote IVM data update sub-routine 700 may proceed to execution block 715.

Remote IVM data update sub-routine 700 may generate a new private/public key pair at execution block 710.

Remote IVM data update sub-routine 700 may associate the generated key pair with the user identifier at execution block 712.

Remote IVM data update sub-routine 700 may add the generated private key to a response message at execution block 713.

Remote IVM data update sub-routine 700 may generate one or more new token sets at execution block 715.

Remote IVM data update sub-routine 700 may associate the generated token sets with the user identifier at execution block 716.

Remote IVM data update sub-routine 700 may add the generated challenges to the response message at execution block 718.

Remote IVM data update sub-routine 700 may terminate by returning the response message at execution block 799.

### Exemplary Secure Access Routine

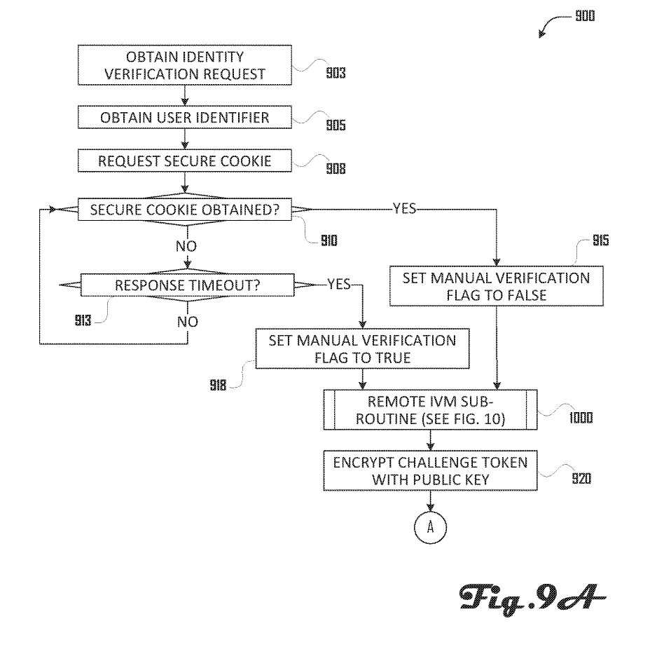

FIG. 8 illustrates an exemplary secure access routine 800. Secure access routine 800 may represent a portion of the functionality of merchant service 325B being executed by central processing unit 303B of web server 300B in cooperation with various other hardware and software components of the present methods and symptoms.

Secure access routine 800 may obtain a secure access request at execution block 903.

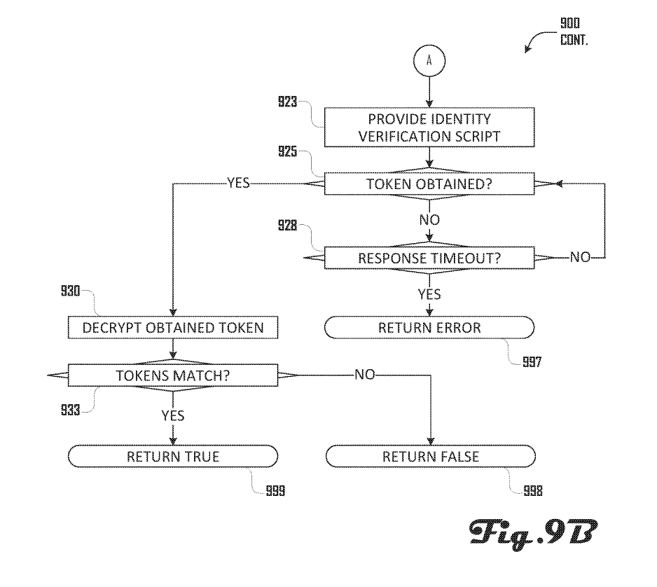

Secure access routine 800 may call an identity verification sub-routine 900, described below with reference to FIG. 9.

At decision block 804, if identity verification sub-routine 900 returns a true value, then secure access routine 800 may permit the requested access at execution block 805; otherwise secure access routine 800 may deny the requested access at execution block 808.

Secure access routine 800 may terminate at termination block 899.

### Exemplary Identity Verification Sub-Routine

FIGS. 9A-B illustrate an exemplary identity verification sub-routine 900. Identity verification sub-routine 900 may represent a portion of the functionality of merchant service 325B.

Referring to FIG. 9A, identity verification sub-routine 900 may obtain an identity verification request at execution block 903.

Identity verification sub-routine 900 may obtain a user identifier at decision block 905.

Identity verification sub-routine 900 may request a secure cookie from arbitrary client device 200A at execution block 908.

At decision block 910, if a secure cookie is obtained from arbitrary client device 200A, then identity verification sub-routine 900 may proceed to execution block 915; otherwise identity verification sub-routine 900 may proceed to decision block 913.

At decision block 913, if a predefined timeout value for obtaining a secure cookie has been exceeded, then identity verification sub-routine 900 may proceed to execution block 918; otherwise identity verification sub-routine 900 may loop back to decision block 910.

Identity verification sub-routine 900 may set a manual verification flag value to false at execution block 915.

Identity verification sub-routine 900 may set the manual verification flag value to true at execution block 918.

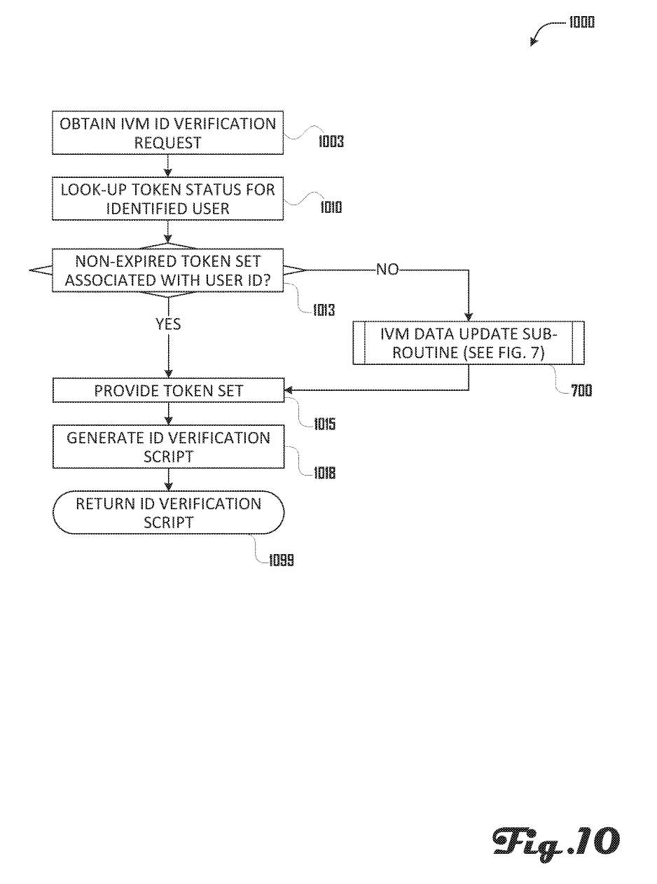

Identity verification sub-routine 900 may call a remote IVM sub-routine 1000, described below with reference to FIG. 10. Identity verification sub-routine 900 may provide remote IVM sub-routine 1000 with the manual verification flag value. As is described below, IVM sub-routine 1000 may return an unencrypted token set, a public encryption key, and an identity verification script. The challenge token in the token set may have a manual verification value set according to the corresponding to the manual verification flag provided to IVM sub-routine 1000.

Identity verification sub-routine 900 may encrypt the challenge token with the public encryption key at execution block 920.

Referring now to FIG. 9B, identity verification sub-routine 900 may provide the identity verification script and the encrypted challenge token to arbitrary client device 200A at execution block 923.

At decision block 925, if a token is obtained from arbitrary client device 200A in response to the identity verification script, then identity verification sub-routine 900 may proceed to execution block 930; otherwise identity verification sub-routine 900 may proceed to decision block 928.

At decision block 928, if a predefined timeout value for obtaining a token from arbitrary client device 200A in response to the identity verification script has been exceeded, then identity verification sub-routine 900 may proceed to return block 997; otherwise identity verification sub-routine 900 may loop back to decision block 920.

Identity verification sub-routine 900 may decrypt the token obtained from arbitrary client device 200A using the public-key at execution block 930.

At decision block 933, if the decrypted token matches either the unencrypted verification token or the unencrypted manual verification token, then identity verification sub-routine 900 may proceed to execution block 998; otherwise identity verification sub-routine 900 may proceed to execution block 999.

### Exemplary Remote IVM Sub-Routine

FIG. 10 illustrates an exemplary remote IVM sub-routine 1000. Remote IVM sub-routine 1000 may represent a portion of the functionality of IVM service 325A.

IVM sub-routine 1000 may obtain IVM ID verification request at execution block 1003.

IVM sub-routine 1000 may look up a token status corresponding to a user identifier provided in the IVM ID verification request at execution block 1010.

At decision block 1013, if at least one non-expired token set is associated with the user identifier, then IVM sub-routine 1000 may proceed to execution block 1015; otherwise IVM sub-routine 1000 may call IVM data update sub-routine 700, described above, and then proceed to execution block 1015.

IVM sub-routine 1000 may provide a token set obtained from remote IVM data update sub-routine 700 to a data communication address associated with the user identifier (e.g. the data communication address for mobile client device 200B) at execution block 1015.

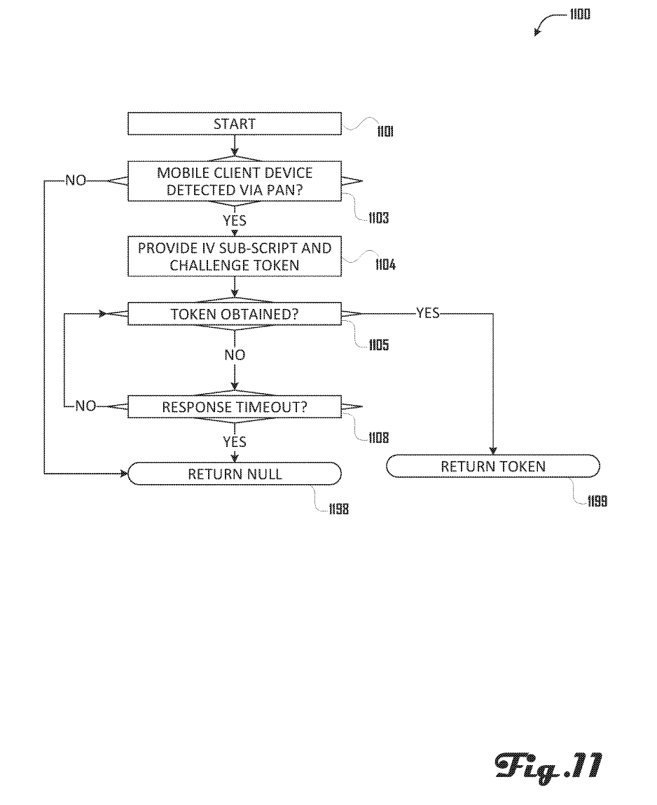

IVM sub-routine 1000 may generate an identity verification script 1100, described below with reference to FIG. 11, at execution block 1018. The content of the identity verification script may vary depending on the manual verification flag value.

IVM sub-routine 1000 may return the identity verification script, token set, and public encryption key at return block 1099.

### Exemplary Identity Verification Script

FIG. 11 illustrates an exemplary identity verification script 1100. Identity verification script 1100 may represent a portion of the functionality of IVM service 325A being executed by central processing unit 203A of arbitrary client device 200A in cooperation with various other hardware and software components of the present methods and symptoms.

Identity verification script 1100 begins at starting block 1101.

At decision block 1103, if a mobile client device is detected via a personal area network, then identity verification script 1100 may proceed to execution block 1104; otherwise identity verification script 1100 may proceed to return block 1198.

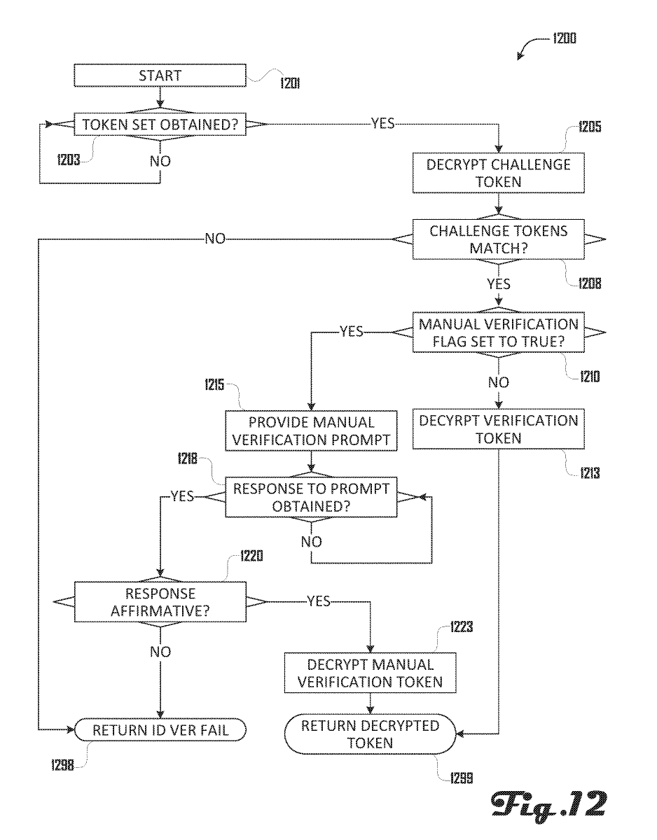

Identity verification script 1100 may provide the encrypted challenge token and an identity verification sub-script 1200, described below with reference to FIG. 12, to the mobile client device at execution block 1104.

At decision block 1105, if an encrypted token has been obtained from the mobile client device responsive to identity verification sub-script 1200, then identity verification script 1100 may proceed to return block 1199; otherwise identity verification script 1100 may proceed to decision block 1108.

At decision block 1108, if a predefined timeout value for obtaining an encrypted token from mobile client device 200B responsive to identity verification sub-script 1200 has been exceeded, then identity verification script 1100 may proceed to return block 1198; otherwise identity verification sub-routine 900 may loop back to decision block 1105.

Identity verification script 1100 may return a null value at return block 1198.

Identity verification script 1100 may return the encrypted token at return block 1199.

### Exemplary Identity Verification Sub-Script

FIG. 12 illustrates an exemplary identity verification sub-script 1200. Identity verification sub-script 1200 may represent a portion of the functionality of IVM service 325A being executed by central processing unit 203B of mobile client device 200B in cooperation with various other hardware and software components of the present methods and symptoms.

Identity verification sub-script 100 begins at starting block 1201.

At decision block 1203, if a token set has been obtained from IVM server 300A, then identity verification sub-script 1200 may proceed to execution block 1205.

Identity verification sub-script 1200 may decrypt the challenge token obtained from arbitrary client device 200A at execution block 1205.

At decision block 1208, if the decrypted challenge token matches the challenge token obtained from IVM server 300A, then identity verification sub-script 1200 may proceed to decision block 1210; otherwise identity verification sub-script 1200 may proceed to return block 1298.

At decision block 1210, manual verification flag value is true, then identity verification sub-script 1200 may proceed to execution block 1215; otherwise identity verification sub-script 1200 may proceed to execution block 1213.

Identity verification sub-script 1200 may decrypt the verification token obtained from IVM server 300A at execution block 1213 and then proceed to return block 1299.

Identity verification sub-script 1200 may provide a manual prompt, e.g. via display 215B, at execution block 1215.

At decision block 1218, if a response to the manual prompt has been obtained, e.g. via user input 213A, then identity verification sub-script 1200 proceed to decision block 1220.

At decision block 1220, if the obtained response is affirmative, then identity verification sub-script 1200 may proceed to execution block 1223; otherwise identity verification sub-script 1200 may proceed to return block 1298.

Identity verification sub-script 1200 may decrypt the manual verification token obtained from IVM server 300A with the private key also obtained from the IVM server at execution block 1223.

Identity verification sub-script 1200 may return an identity verification fail value to identity verification script 1100 at return block 1298.

Identity verification sub-script 1200 may return the decrypted verification token (or the decrypted manual verification token) to identity verification script 1100 at return block 1299.

### CONCLUSION

Although specific embodiments have been illustrated and described herein, a variety of alternate and/or equivalent implementations may be substituted for the specific embodiments shown and described without departing from the scope of the present disclosure. This application is intended to cover any adaptations or variations of the embodiments discussed herein.

I claim:

1. A multifactor authentication system, for authorizing access a first client device to access a secure resource stored on a web server, the system comprising:
a computer processing unit in data communication with said data store; and
memory in data communication with said computer processing unit and including instructions for causing said processing unit to execute a first method, said first method including:
a) obtaining an identification verification request from the web server, said identification verification request including a user identifier;
b) obtaining a data communication address associated with a second client device, said second client device being associated with said user identifier;
c) selecting a challenge token and a verification token;
d) providing, to said data communication address, a first copy of said challenge token and a first copy of said verification token to said data communication address;
e) providing, to the web server, a second copy of said challenge token and a second copy of said verification token and instructions for causing the web server to execute a second method, said second method including:
1) providing, to said first client device, said second copy of said challenge token and instructions for causing said first client device to execute a third method, said third method including:
A) determining said second client device is in physical proximity to said first client device;
B) providing, to said second client device, said second copy of said challenge token and instructions for causing said second client device to execute a fourth method, said fourth method including:
i) determining said second copy of said challenge token matches said first copy of said challenge token; and
ii) providing, to said first client device, said first copy of said verification token;
C) obtaining, from said second client device, said first copy of said verification token; and
D) providing said first copy of said verification token to the web server;
2) obtaining said first copy of said verification token from said first client device;
3) determining said first copy of said verification token matches said second copy of said verification token; and
4) authorizing said first client device to access to the secure resource.

2. The multifactor authentication system of claim 1, wherein said first client device and said second client device are in data communication with one another via a personal area network.
